(19) United States
(12) Patent Application Publication
(10) Pub. No.: US 2012/0075665 A1
(43) Pub. Date: Mar. 29, 2012

(54) PRINTING SYSTEM, PRINTING CONTROL APPARATUS AND PRINTING APPARATUS

(75) Inventor: Hirofumi SAMBE, Kanagawa (JP)

(73) Assignee: FUJI XEROX CO., LTD., Tokyo (JP)

(21) Appl. No.: 13/034,830

(22) Filed: Feb. 25, 2011

(30) Foreign Application Priority Data
Sep. 24, 2010 (JP) 2010-214313

(51) Int. Cl. G06F 3/12

(52) U.S. Cl. 358/1.15

(57) ABSTRACT

A print server acquires print information and selects candidate printers to perform print processing based on the print information among a plurality of printers. The print server transmits list information indicating a list of the selected candidate printers and transmits the print information to one of the selected candidate printers. The plurality of printers acquires the list information transmitted from the print server, and transmits the print information to at least another printer selected from the printers indicated in the list information when the print information transmitted from the print server is acquired.

### CROSS-REFERENCE TO RELATED APPLICATION

This application is based on and claims priority under 35 USC 119 from Japanese Patent Application No. 2010-214313 filed on Sep. 24, 2010.

### BACKGROUND

### Technical Field

The present invention relates to a printing system, a printing control apparatus and a printing apparatus.

### SUMMARY

According to an aspect of the invention, a printing system includes a printing control apparatus and a plurality of printing apparatuses. The printing control apparatus includes an acquisition unit, a selection unit, a list information transmission unit and a print information transmission unit. The acquisition unit acquires print information. The selection unit selects candidate printing apparatuses from among the plurality of printing apparatuses based on the print information. The candidate printing apparatuses perform print processing which corresponds to the print information. The list information transmission unit transmits list information indicating a list of the selected candidate printing apparatuses to one of the selected candidate printing apparatuses. The print information transmission unit transmits the print information to the one of the selected candidate printing apparatuses. At least one of the plurality of printing apparatuses includes an acquire unit and a transmission unit. The acquire unit acquires the list information transmitted from the list information transmission unit. When the one of the selected candidate printing apparatus acquires the print information transmitted from the print information transmission unit, the transmission unit transmits the print information to at least another printing apparatus which is selected from among the plurality of printing apparatuses by the selection unit and which is indicated in the list information.

### BRIEF DESCRIPTION OF THE DRAWINGS

Exemplary embodiments of the invention will be described in detail based on the following figures, wherein:

FIG. 1 is a constitutional view of the printing system of the first embodiment;

FIG. 2 is a sequence diagram of the print control processing;

FIG. 3 shows one example of the print job list;

FIG. 4 shows one example of the print job list;

FIG. 5 shows one example of the print job list;

FIG. 6 shows one example of the print job list;

FIG. 7 shows one example of the print job list;

FIG. 8 is a functional block diagram of the print server;

FIG. 9 is one example of the logical printer information table;

FIG. 10 is one example of the physical printer information table;

FIG. 11 is one example of print history data;

FIG. 12 is one example of the priority table;

FIG. 13 is a functional block diagram of the printer;

FIG. 14 is a sequence diagram of the print control processing of the second embodiment; and

FIG. 15 is a sequence diagram of the print control processing of the third embodiment.

### DETAILED DESCRIPTION

Hereinafter, illustrative embodiments to implement the present invention (hereinafter, “embodiment”) will be described with reference to the drawings.

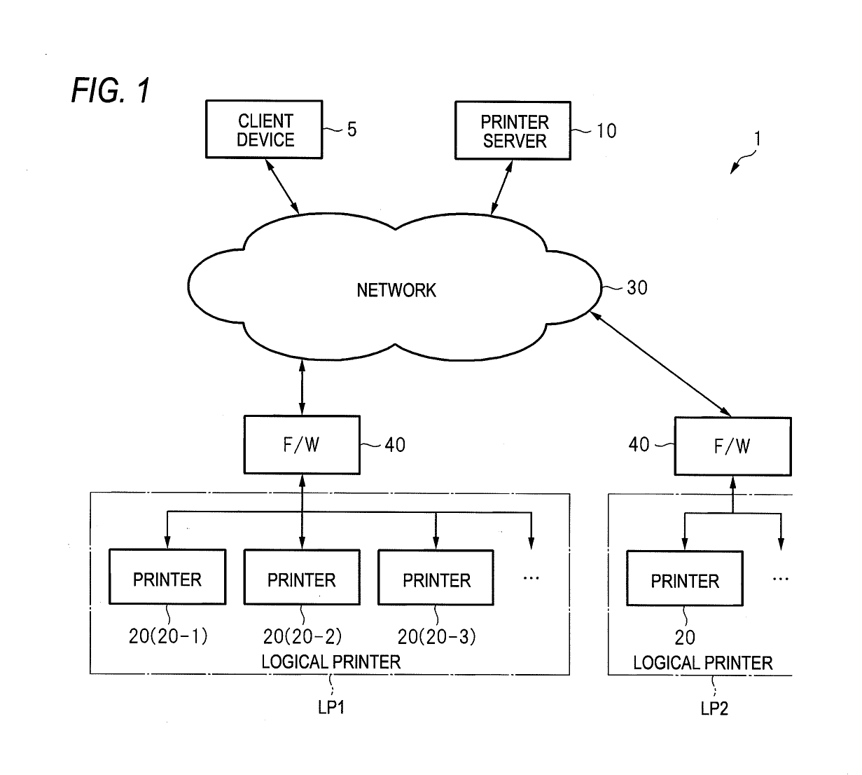

FIG. 1 shows a constitutional view of the printing system of the first embodiment. As illustrated in FIG. 1, a printing system 1 includes a client device 5, a print server 10, and a plural of printers 20 (20-1, 20-2, 20-3 . . . ). The client device 5, the print server 10, and the plural of printers 20 each are connected to communicate with each other through a network 30. And, a firewall 40 is provided between the printers 20 and the network 30.

The client server 5 is a computer operated by a user. The client server 5 generates a print job (print data) in response to the user's instructions and transmits the generated print job to the print server 10.

The print server 10 is a computer which performs print processing by managing the print job received from the client server 5 and by transmitting the print job to the plural of printers 20.

A plural of printers 20 is a device which performs print processing based on a print job. According to the present embodiment, a plural of logical groups (for example, a single group of printers included in the same local area network, and the like) is provided in the plural of printers 20. For example, in the example illustrated in FIG. 1, a logical printer LP1 and a logical printer LP2 are set. And, the information of a physical printer included in each logical printer may be determined by the print server 10 and physical printers included in each logical printer may overlap with each other.

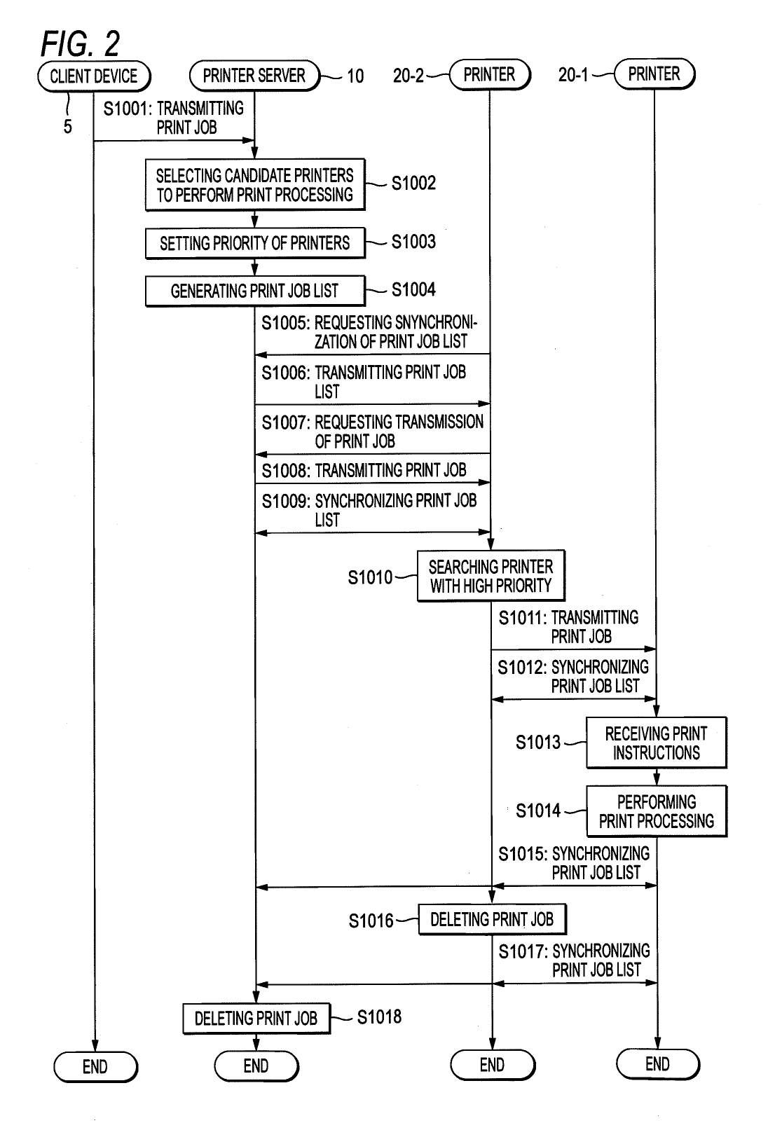

Below is a summary of the print control processing of the present embodiment with reference to the sequence view of the print control processing performed in the printing system 1 illustrated in FIG. 2.

As illustrated in FIG. 2, the client server 5 generates a print job based on instructions received from a user A and transmits the generated print job to the print server 10 (S1001). And, in the present embodiment, it is desirable to designate a logical printer as a print job destination. In this sequence example, a logical printer LP1 is designated as a print job destination.

Based on the print job received from the client device 5, the print server 10 selects candidate printers 20 which perform print processing based on the print job (S1002). For example, during S1002, the selection of printers 20 may be performed by extracting physical printers which satisfy with predetermined print conditions designated for the print job (i.e., whether or not to satisfy with conditions such as a paper size, duplex printing, color printing, optional functions, and the like) among physical printers included in the logical printer LP1 designated for the print job. Further, the print server 10 sets priority of each of the selected printer 20 (S1003). The priority of the selected printers 20 may be set higher, for example, if a matching rate with the user A's previous use frequency or print conditions is high.

The print server 10 generates a print job list based on the print job, the selected printers, and the priority thereof (S1004).

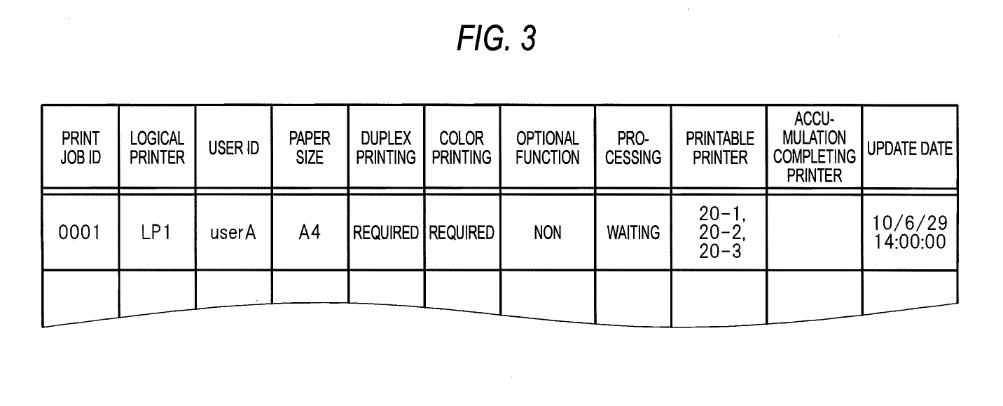

FIG. 3 shows one example of a print job list generated during S1004. As illustrated in FIG. 3, the print job list is generated in relation to a print job ID for identifying a print job, a logical printer name of destination, a user ID who orders a print job, a paper size, duplex printing, color printing, optional functions, a printable printer selected for a print job, an accumulation completing printer that refers to a printer 20 in which print jobs are accumulated, processing information indicating how further a print job is proceeded, and an update date. And, in the print job list example illustrated in FIG. 3, printers 20 are arranged in order of having a higher priority in the printable printer item. In the example illustrated in FIG. 3, the order of printers having a higher priority is a printer 20-1, a printer 20-2, and a printer 20-3.

The printers 20 each perform a request for synchronization of a print job list included in the printable printer item to the print server 10 in a predetermined time interval (S1005). In this sequence example, if a printer 20-2 requests synchronization to the print server 10, the print server 10 determines the printer 20-2 performing the request for synchronization as a printable printer. In this sequence, a print job ID 0001 including the printer 20-2 as a printable print is determined as a print job, and a print job list associated with the print job ID 0001 is transmitted from the print server 10 to the printer 20-2 (S1006).

Based on the print job list received from the print server 10, the printer 20-2 requests transmission of the print job for the print job ID 0001 to the print server 10 (S1007). In this sequence example, if the holding time of each printer 20 is set 0, the print server 10 transmits the print job for the print job ID 0001 to the printer 20-2 in response to the request from the printer 20-2 (S1008).

When the print server 10 transmits the print job to the printer 20-2, the print server 10 updates a print job list associated with the print job ID 0001 and synchronizes the updated print job list with the printer 20-2 (S1009).

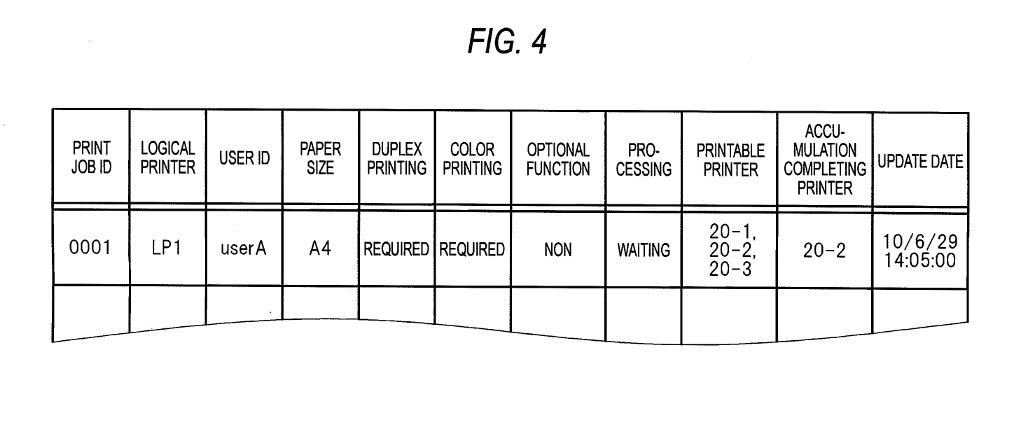

FIG. 4 shows one example of a print job list synchronized during S1009. In the example illustrated in FIG. 4, update date information is updated concurrently with listing a printer 20-2 in the accumulation completing printer item.

With reference to the synchronized print job list, the printer 20-2 searches a printer 20 having a higher priority compared to a priority of the printer 20-2 from the printable printer item of the print job list (S1010). In this sequence example, during S1010, a printer 20-1 having a higher priority than a priority of the printer 20-2 is searched.

The printer 20-2 transmits the print job to the searched printer 20-1 (S1011). And the printer 20-2 updates and synchronizes the print job list (S1012).

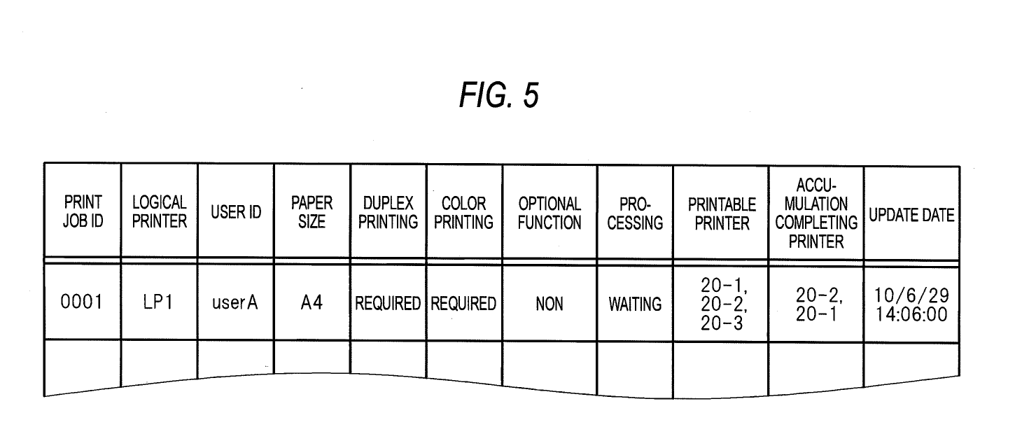

FIG. 5 shows one example of a print job list synchronized during S1012. In the example illustrated in FIG. 5, update date information is updated concurrently with newly listing a printer 20-1 in the accumulation completing printer item.

Upon receipt of print instructions of a print job ID 0001 from a user A (S1003), the printer 20-1 performs print processing based on the print job of the print job ID 0001 (S1014). After the printer 20-1 completes the print processing of the print job ID 0001, the printer 20-1 updates and synchronizes the print job list of the print job ID 0001 concurrently with deleting the print job of the print job ID 0001 (S1015).

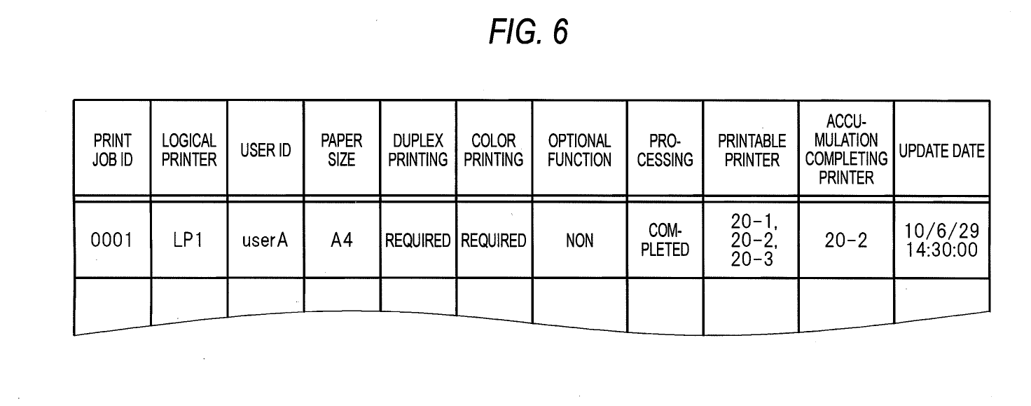

FIG. 6 shows one example of a print job list synchronized during S1015. In the example illustrated in FIG. 6, concurrently with updating processing information to “completed” and deleting a printer 20-1 from the accumulation completing printer item, update date information is updated. The processing information item may be updated to indicate the information of “printer 20-1 completed” in order to show which printer print is complete, as well as “completed.”

When the processing information in the synchronized print job list of the printer 20-2 is indicated as “print completed” in another printer, the printer 20-2 deletes the print job (S1016). And the printer 20-2 updates and synchronizes the print job list (S1017).

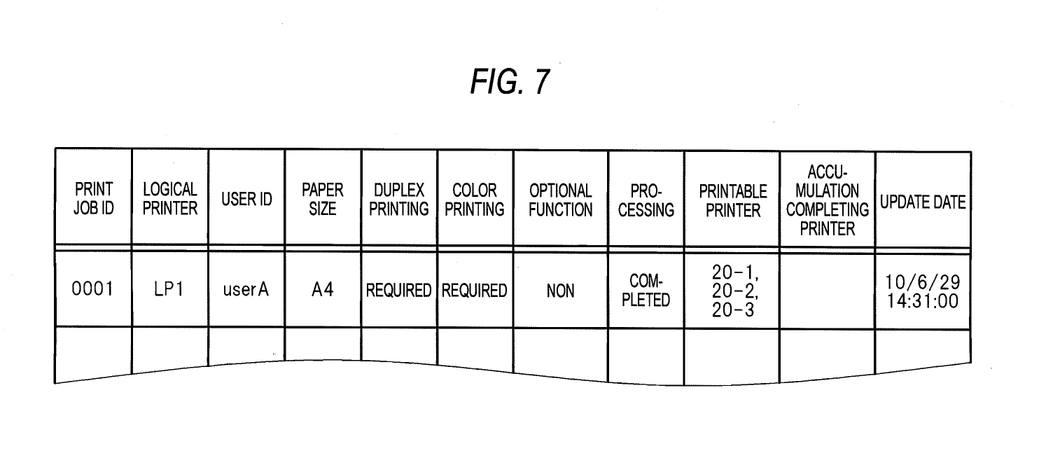

FIG. 7 shows one example of a print job list synchronized in S1017. In the example illustrated in FIG. 7, concurrently with deleting a printer 20-2 from the accumulation completing printer item, update date information is updated.

For example, when processing information is indicated as “completed” and a printer name is not stored in the accumulation completing printer item in the synchronized print job list, a print server 10 deletes the print job (S1018) and ends the processing.

In order to implement the above processing, below is an explanation of functions of the print server 10 and printers 20 regarding the present embodiment. An explanation of the print server 10 is first provided.

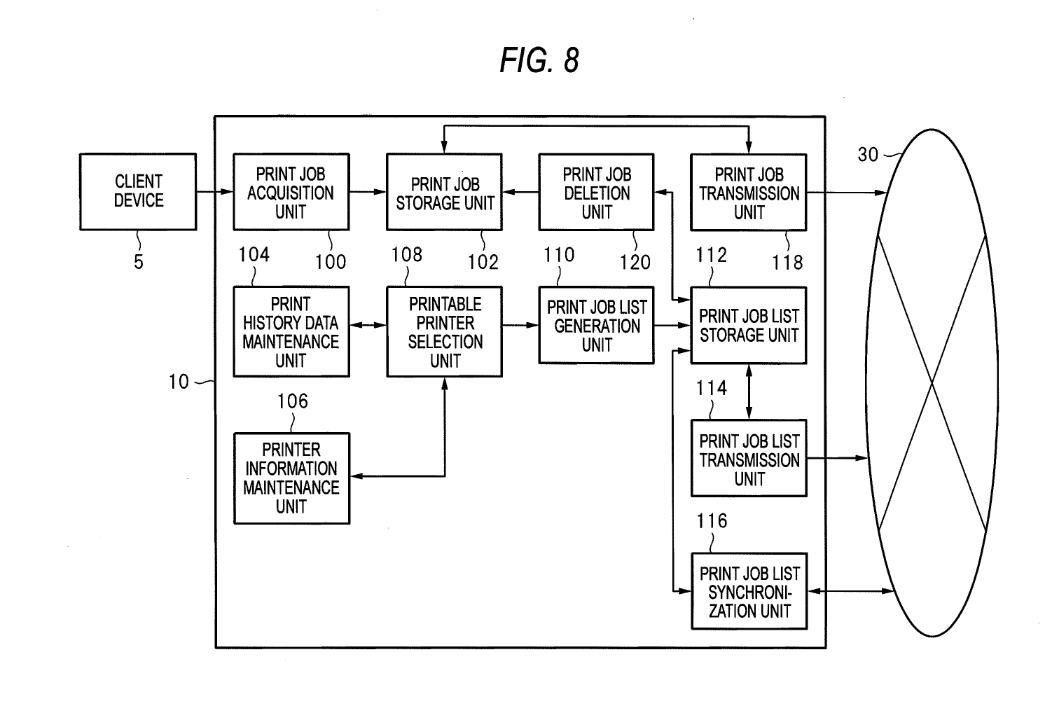

FIG. 8 is a functional block diagram of the print server 10 regarding the present embodiment. As illustrated in FIG. 8, the print server 10 includes a print job acquisition unit 100, a print job storage unit 102, a print history data maintenance unit 104, a printer information maintenance unit 106, a printable printer selection unit 108, a print job list generation unit 110, a print job list storage unit 112, a print job list transmission unit 114, a print job list synchronization unit 116, a print job transmission unit 118, and a print job deletion unit 120.

Functions of each of said units may be implemented by a computer reading a program stored at a computer readable information storage medium and executing the program, wherein the computer includes a control unit such as CPU and the like; a storage unit such as a memory and the like; and a communication unit for receiving/transmitting data from/to an external device and the like. The program may be provided to the print server 10, which is a computer, by an optical disk, a magnetic disk, a magnetic tape, an optical magnetic disk, a flash memory and the like, and may be provided by data communication network such as Internet and the like.

The print job acquisition unit 100 acquires a print job transmitted from the client device 5.

The print job storage unit 102 stores the print job acquired by the print job acquisition unit 100.

The printer information maintenance unit 106 maintains information of each printer 20 provided in the printing system 1. For example, a logical printer information table and a physical printer information table explained hereinafter are maintained in the printer information maintenance unit 106.

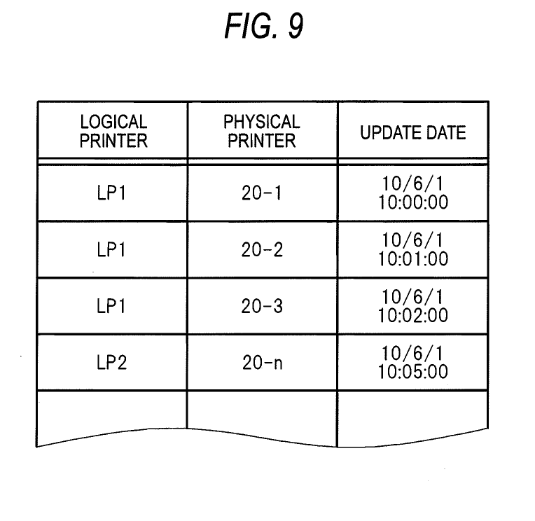

FIG. 9 shows one example of a logical printer information table. A logical printer information table is a table maintaining the corresponding relationship between a logical printer and a physical printer in the printing system 1. For example, the logical printer information table is made in relation to logical printer names identifying logical printers, physical printer names included in logical printers, and update dates thereof.

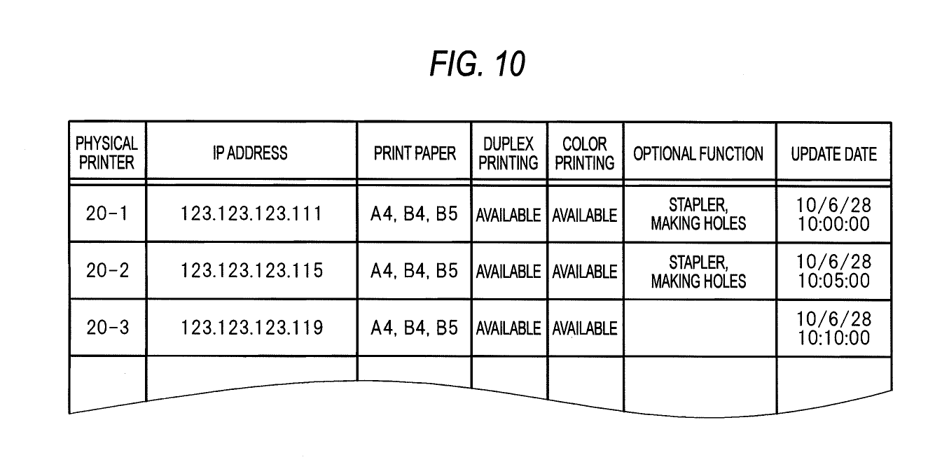

FIG. 10 shows one example of a physical printer information table. A physical printer information table is a table maintaining device properties information such as IP address, which is location information (destination information), or function information of each physical printer. For example, the physical printer information table is made in relation to physical printer names identifying physical printers, IP addresses, available paper sizes, whether duplex printing is available, whether color printing is available, optional functions, and update dates thereof.

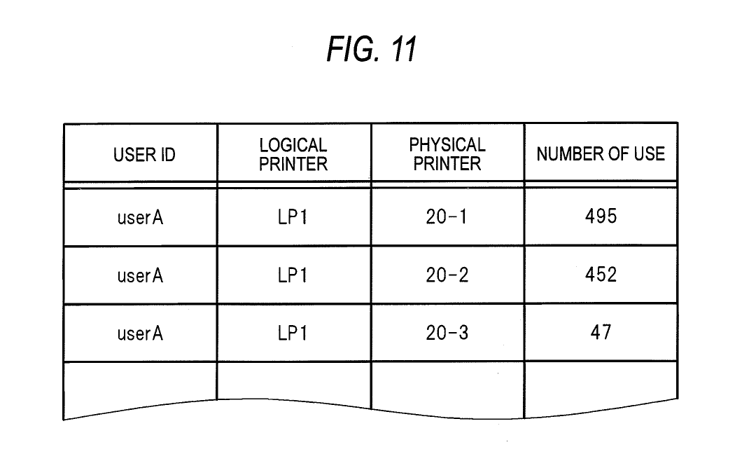

The print history data maintenance unit 104 separately maintains print history data for each user. FIG. 11 shows one example of print history data maintained by the print history data maintenance unit 104. In the example illustrated in FIG. 11, print history data is made in relation to user IDs, logical printers designated as a destination by a user, physical printers performing print processing, and the number of use.

The printable printer selection unit 108 selects candidate printers 20 to perform print processing based on a print job acquired by the print job acquisition unit 100 from among a plurality of printers provided in the printing system 1. For example, the printable printer selection unit 108 searches physical printers related to logical printer names designated as destinations with respect to print jobs from a logical printer information table. Next, the printable printer selection unit 108 extracts printers that satisfy with predetermined conditions for print jobs (i.e., whether or not to satisfy with conditions such as duplex printing, color printing, optional functions and the like), from among the searched physical printers, and selects the extracted printers as printable printers.

Also, the printable printer selection unit 108 calculates, for example, with respect each of the selected printers 20, a previous use rate of each printer 20 by a user who orders a print job, and sets priority in order which the calculated use rate is higher. The use rate is the number of the user's previous designation of a logical printer as a destination in the print job, based on print history data maintained in the print history maintenance unit 104, and is calculated by subtracting the number of actual use of each printer 20.

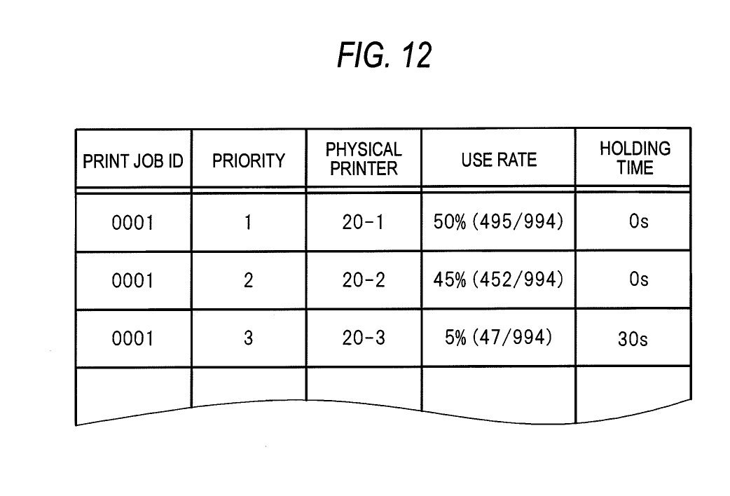

FIG. 12 shows one example of a priority table indicating priority set with respect to printer 20 selected as printable printers. As illustrated in FIG. 12, the priority table is made in relation to print job IDs, priority of printers, physical printer names of printable printers, use rates, and holding times. And, a holding time is a time to hold the transmission to the printer 20 when the printer 20 requests transmission of a print job. For example, if a use rate difference with a printer 20 having the highest priority is less than a threshold, the transmission of a print job is set to start in 0 second, namely, shortly after receiving a request for transmission of the print job, and if a user rate difference is greater than the threshold, the transmission is set to start in 30 seconds and the like, so that the starting of the transmission may be hold for a given time period and a request for transmission from another printer may be received.

The print job list generation unit 110 generates a list of printable printers selected by the printable printer selection unit 108 with respect to a print job or a list including processing information of a print job. One example of a print job list generated by the print job list generation unit 110 is already illustrated in FIG. 3. And, the print job list generation unit 110 may generate a corresponding print job list whenever it acquires a print job from the print job acquisition unit 100.

The print job list storage unit 112 stores the print job list generated by the print job list generation unit 110.

In the case of receiving a request for synchronization of a print job list from the printer 20, the print job list transmission unit 114 extracts a print job list including the printer 20 in the printable printer item from the print job list storage unit 112, and transmits it. For example, a request for synchronization of a print job list may include information of the print job list maintained by a printer 20. In that case, the print job list transmission unit 114 may search a print job list including print job IDs that are not maintained by the printer requesting the synchronization from the print job list storage unit 112 and transmit it.

In the case of receiving a request for synchronization of a print job list from the printer 20, the print job list synchronization unit 116 synchronizes a print job list maintained by the printer 20 and a print job list stored at the print job list storage unit 112. For example, a request for synchronization of a print job list may include information maintained by the printer 20. In that case, information in a print job list including a new update date may be used to overwrite information in another print job list.

In the case of receiving a request for transmission of a print job from the printer 20, the print job transmission unit 118 transmits the print job to the printer 20 if the printer 20 initially satisfies with predetermined conditions. For example, said predetermined conditions may be condition 1: a print job has not been transmitted yet, or conditions 1 and 2: holding time is over with respect to the printer 20 which receives a transmission request. In the latter case, in the case of receiving a request for transmission of a print job, if the print job transmission unit 118 already transmits the print job to any one of printers 20, it does not perform the requested print job transmission. If the print job transmission unit 118 does not transmit the print job to any one of printers 20 and the holding time predetermined in the priority table is not over with respect to the printer 20, the print job transmission unit 118 may transmit the print job. Whether the holding time is over or not can be determined by storing the time of receiving the first transmission request from the printer 20 and printer names. And, in the case of receiving a request for transmission of a print job from said printer 20 again after the holding time is over with respect to a printer 20 for which a transmission request is received once, the print job transmission unit 118 may transmit the print job to said printer 20.

If processing information of the print job list synchronized by the print job list synchronization unit 116 indicates “print completed,” the print job deletion unit 120 deletes the print job corresponding to said print job list from the print job storage unit 112. Also, if processing information of the synchronized print job list indicates “print completed” and if the printer 20 is not designated in the printable printer item of said print job list, the print job deletion unit 120 may delete the print job.

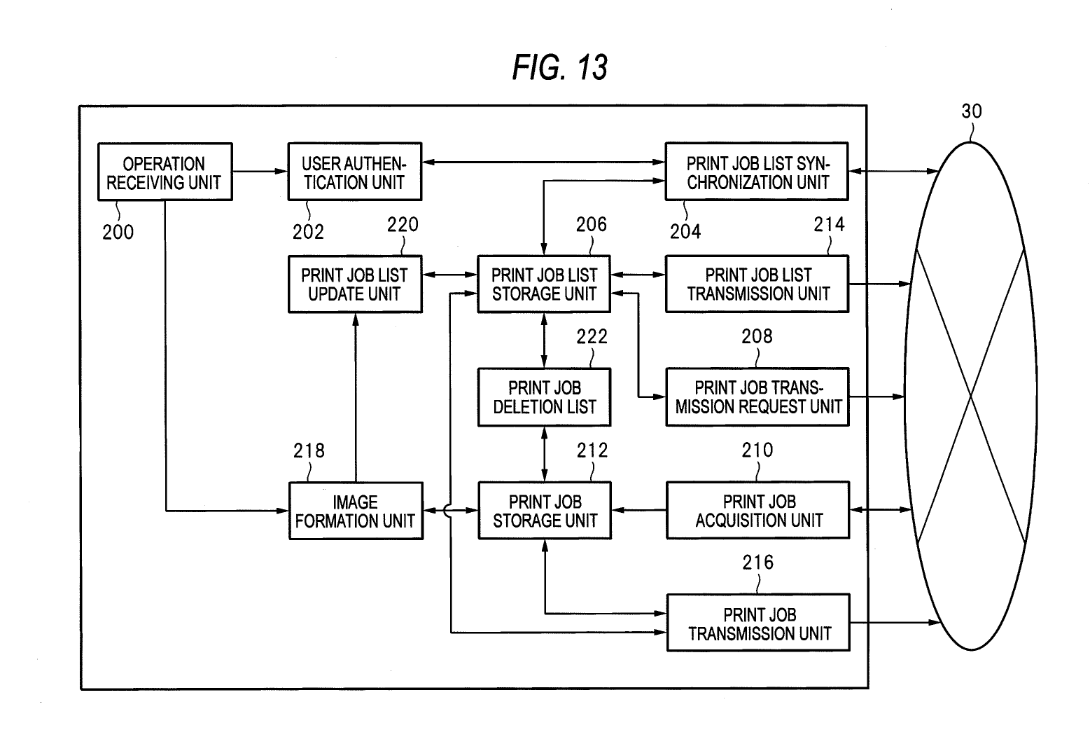

Below is an explanation of functions of printers 20 with reference to the functional block diagram illustrated in FIG. 13. And, in the present embodiment, each printer 20 included in the printing system 1 is deemed to have the functions illustrated in FIG. 13.

As illustrated in FIG. 13, printers 20 includes an operation receiving unit 200, a user authentication unit 202, a print job list synchronization unit 204, a print job list storage unit 206, a print job transmission request unit 208, a print job acquisition unit 210, a print job storage unit 212, a print job list transmission unit 214, a print job transmission unit 216, an image formation unit 218, a print job list update unit 220, and a print job deletion unit 222.

Functions of each of said units may be implemented by a computer reading a program stored at a computer readable information storage medium and executing the program, wherein the computer includes a control unit such as CPU and the like; a storage unit such as a memory and the like; a communication unit for receiving/transmitting data from/to an external device; and a hardware such as a print engine performing image forming process and the like. The program may be provided to the print server 10, which is a computer, by an information storage medium such as an optical disk, a magnetic disk, a magnetic tape, an optical magnetic disk, a flash memory and the like, and may be provided by data communication network such as Internet and the like.

The operation receiving unit 200, for example, may be implemented by an operation panel including a liquid display or an operation button, and the like, and receives information from a user through said operation panel. Also, the operation receiving unit 200 may include an interface receiving/transmitting data from/to an IC card. In this case, the operation receiving unit 200 may read user authentication information and the like stored at the IC card through said interface.

The user authentication unit 202 performs user authentication based on user authentication information received from the operation receiving unit 200. User authentication information may be directly inputted by a user or may be read from an IC card. Upon authentication of a user by a user authentication unit 201, the user is permitted to use a print 20.

The print job list synchronization unit 204 performs a request for synchronization from a print job list including itself as a printable printer with respect to the print server 10 or another printer 20, and synchronizes information of the print job list with said print server 10 or another printer 20. The print job list synchronization unit 204 may perform a request for synchronization of a print job list in a predetermined time interval (namely, regularly), when the printer 20 is in idle, when a printer 20 receives an operation input from a user, or in the timing when any one thereof is combined.

The print job list storage unit 206 stores a print job acquired by the print job acquisition unit 204.

The print job transmission request unit 208 performs a request for transmission of a print job indicated in the print job list stored at the print job list storage unit 206 with respect to the print server 10 or another printer 20. For example, if performing a request for transmission of a print job with respect to the print server 10, the print job transmission request unit 208 may extract a print job list, in which printer information is not indicated in the accumulation completing printer item, and may perform such request with respect to a print job indicated in the extracted print job list. Also, if printer information is indicated in the accumulation completing printer item of a print job list, the print job transmission request unit 208 may perform a request for transmission of a print job to any one of the stored printers 20. A request for transmission of a print job may perform a request for synchronization of a print job list in a predetermined time interval (namely, regularly), when a printer 20 is in idle, when a printer 20 receives an operation input from a user, or in the timing when any one thereof is combined.

The print job acquisition unit 210 acquires a print job transmitted from the print server 10 or anther printer 20 based on the transmission request from the print job transmission request unit 208.

The print job storage unit 212 stores a print job acquired from the print job acquisition unit 210.

The print job list transmission unit 214 transmits a print job list stored at a print job list storage unit 206 to at least one printer 20 stored at the printable print item of said print job list. For example, the print job transmission unit 214 may transmit a print job list to all printers 20 stored at the printable print item of the print job list.

The print job transmission unit 216 transmits a print job stored at the print job storage unit 212 to at least one printer 20 stored at the printable printer item of a print job list which is stored to corresponding to said print job in the print job list storage unit 206. For example, the print job transmission unit 216 may transmit a print job, among printers stored at the printable printer item in the print job list, to printers 20 having a higher priority than itself, or to printers 20 having a lower priority than itself in order having a higher priority. Also, when transmitting a print job to each printer 20, the print job transmission unit 216 may transmit a print job in a predetermined time interval or in a time interval, wherein the lower the priority is, the longer the time interval becomes.

In the case of receiving a request for image formation with respect to a print job designated by a user among print jobs stored at the print job storage unit 212, the image formation unit 218 performs image formation based on the print job.

In the case that a print job is transmitted to another printer 20 by the print job transmission unit 216 or in the case that image formation is performed by the image formation unit 218 based on a print job, the print job list update unit 220 updates a print job list corresponding to the print job. For example, in the case that a print job is transmitted to another printer 20 by the print job transmission unit 216, the print job update unit 220 updates a print job list by adding a destination printer 20 to the accumulation completing printer item of the print job list. In the case that image formation is performed by the image formation unit 218 based on a print job, the print job update unit 220 updates processing information of a print job list as “print completed.” A print job list updated by the print job list update unit 220 is synchronized with the print server 10 or another printer 20 by the print jot list synchronization unit 204.

In the case that image formation is performed by the image formation unit 218 or a synchronized print job list is indicated as “print completed,” the print job deletion unit 222 deletes the corresponding print job from the print job storage unit 212. In the case that the print job is deleted by the print job deletion unit 222, the print job list update unit 220 deletes a printer 20 corresponding to the print job from the accumulation completing print item of the corresponding print job list, and updates the print job list. The updated print job list is synchronized with the print server 10 or another printer 20 by the print job list synchronization unit 204.

According to the printing system described hereinbefore, even if a firewall is provided between the printers 20 and the print server 10, the print job list or the print job can be transmitted to the printers 20 by performing a request for transmission of the print job list or the print job to the print sever 10. Also, in the case that a transmission request from a printer 20 to the print server 10 is regularly performed without user's instructions, a waiting time of user's print processing will be shorten than that of the case where a print job is acquired based on user's instructions. Furthermore, because print job transmission between printers 20 and the print server 10 is completed once, a network error between the printers 20 and the print server 10 is not affected while transmission loads between the printers 20 and the print server 10 being reduced. And, a print job is quickly transmitted from the print server 10 to printers 20 and a print job is transmitted to a printer 20, which is expected to be frequently used by a user, thereby reducing the likelihood which the print job is not maintained with respect to the printer 20 to be used by the user.

According to the printing system 1 described hereinbefore, a print job or a print job list is requested to the print server 10 in timing, which is not based on a user's operation. However, the printing system 1 may be used in combination with a request for a print job or a print job list to the print server 10 in timing which is based on a user's operation.

Also, in the case that synchronization cannot be performed between a printer 20 and the print server 10 due to a network error therebetween and the like, the printer 20 may perform synchronization with another printer 20 indicated in the print job list. Also, in the case that a printer 20 performs a request for transmission of a print job to another printer 20 maintaining the print job, if the print job is not transmitted due to a network error or failure, the print job may be acquired from the print server 10.

Also, according to the printing system 1, a printer 20, to which a print job is transmitted from the print server 10, may transmit the designated print job to another printer 20.

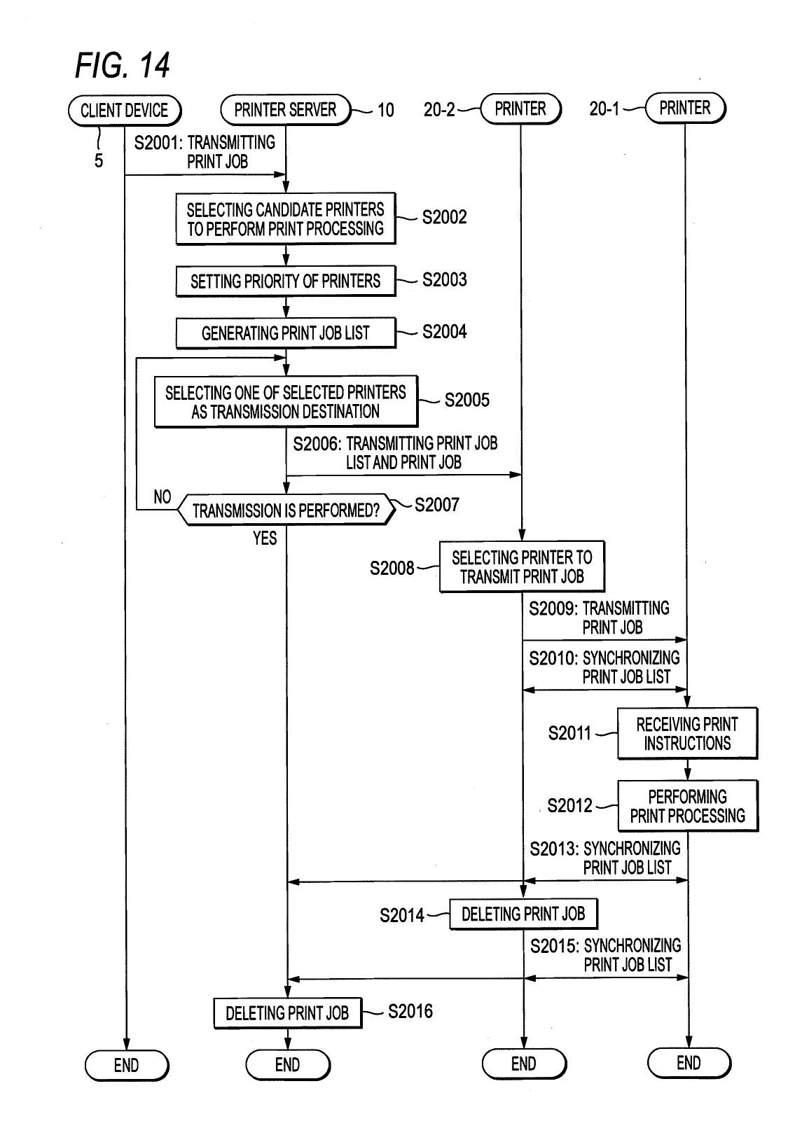

Below is an explanation of the second embodiment of the present invention. The second embodiment is different from the first embodiment in that the print server 10 transmits a print job to a printer 20 in a predetermined timing without a request from the printer 20. Hereinafter, below is an explanation of the print control processing of the second embodiment with reference to the sequence diagram of the print control processing performed in the printing system 1 of the second embodiment, as illustrated in FIG. 14.

As illustrated in FIG. 14, a client device 5 generates a print job based on instructions received from a user A and transmits the generated print job to a print server 10 (S2001). And, according to this embodiment, a logical printer may be designated as a destination of a print job, and in this sequence example, a logical printer LP1 is designated as the destination of a print job.

Based on the print job received from the client device 5, the print server 10 selects candidate printers 20 which perform print processing based on the print job (S2002). For example, during S2002, the selection of printers 20 may be performed by extracting physical printers which satisfy with predetermined print conditions designated for the print job (i.e., whether or not to satisfy with conditions such as a paper size, duplex printing, color printing, optional functions, and the like) among physical printers included in the logical printer LP1 designated for the print job. Also, the print server 10 sets priority of each selected printer 20 (S2003). The priority of the selected printers 20 may be set higher, for example, if a matching rate with the user A's previous use frequency or print conditions is high.

The print server 10 generates a print job list based on a print job, the selected printers, and priority thereof (S2004).

The printer server 10 selects one of the selected printers as a transmission destination (S2005) and transmits a print job list and a print job to the selected printer 20 (S2006). During 2006, in the case that the transmission is not performed (S2007: N), it returns to S2005, performs the processing after selecting a transmission destination again, and performs the next step if the transmission is performed. During S2005, for example, it is preferable to select a printer having a higher priority as a transmission destination. In the case that during 2006, the transmission is not performed to the printer 20 selected during 52005, a printer 20 having the next highest priority may be selected to perform the transmission again and such steps may be repeated until the transmission is completed. Also, the selection of transmission destination is not limited to the above method. A transmission destination may be selected at random. And, in this sequence example, during S2006, because the transmission is not performed to a printer 20-1, the below explanation is made on the premise that a printer 20-2 is selected.

A printer receiving a print job (printer 20-2) selects a printer 20 as a transmission destination from the printable printer item of the print job list with reference to the received print job list (S2008). In this sequence example, during S2008, a printer 20-1 having a higher priority than the printer 20-2 is selected.

The printer 20-2 transmits a print job to the selected printer 20-1 (S2009) and updates the print job list to synchronize it (S2010).

Upon receipt of print instructions of a print job ID 0001 from a user A (S2011), the printer 20-1 performs print processing based on the print job of the print job ID 0001 (S2012). Upon completion of the print job of the print job ID 0001, the printer 20-1 updates and synchronizes the print job list of the print job ID 0001 concurrently with deleting the print job of the print job ID 0001 (S2013).

In the case that the processing information in the synchronized print job list of the printer 20-2 is indicated as “completed,” the printer 20-2 deletes the print job (S2014). And, the printer 20-2 updates and synchronizes the print job list (S2015).

For example, in the case that in the synchronized print job list, processing information is indicated as “completed” and a printer name is not stored in the accumulation completing printer item, the print server 10 deletes the print job (S2016) and ends processing.

In the printing system 1 according to the second embodiment, the print job is maintained with respect to a plurality of printers by transmitting a print job list or the print job to the printers 20, without waiting for a print job list or a request for transmission of the print job from a printer 20. And then, the print job is maintained by transmitting the print job in the printers upon transmission to the printers 20.

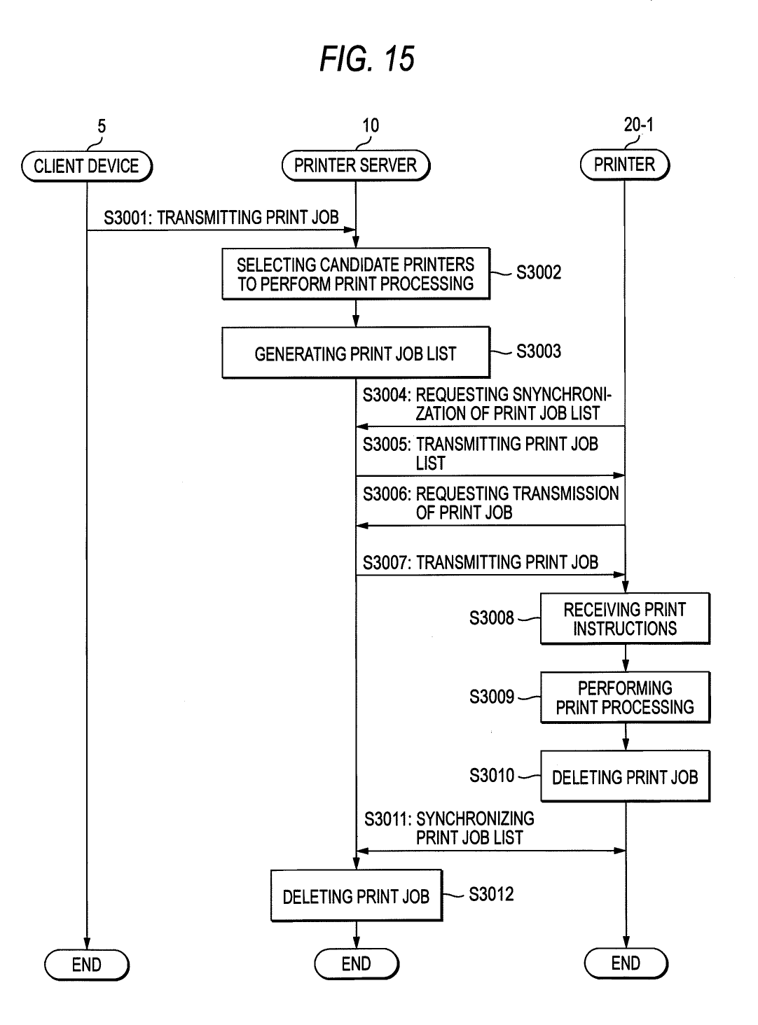

Below is an explanation of the third embodiment of the present invention. The third embodiment is different from the first embodiment in that a printer 20 does not transmits a print job transmitted from the print server 10 to another printer 20. Hereinafter, below is an explanation of the print control processing of the third embodiment with reference to the sequence diagram of the print control processing performed in the printing system 1 of the third embodiment, as illustrated in FIG. 15.

As illustrated in FIG. 15, a client device 5 generates a print job based on instructions received from a user A and transmits the generated print job to a print server 10 (S3001). And, according to this embodiment, a logical printer may be designated as a destination of a print job, and in this sequence example, a logical printer LP1 is designated as the destination of a print job.

Based on the print job received from the client device 5, the print server 10 selects candidate printers 20 which perform print processing based on the print job (S3002). For example, during S3002, the selection of printers 20 may be performed by extracting physical printers which satisfy with predetermined print conditions designated for the print job (i.e., whether or not to satisfy with conditions such as a paper size, duplex printing, color printing, optional functions, and the like) among physical printers included in the logical printer LP1 designated for the print job.

A print server 10 generates a print job list based on a print job, and the selected printers (S3003).

A printer 20 performs a request for synchronization of a print job list in which the printer 20 is included in the printable printer item to the print server 10 in a predetermined time interval (S3004). In this sequence example, if the printer 20-1 requests synchronization to the print server 10, a print job list of a print job ID0001 is transmitted from the print server 10 to the printer 20-1 (S3005).

The printer 20-1 requests transmission of the print job of print job ID0001 based on the print job list received from the print server 10 (S3006). In response to the request from the printer 20-1, the print sever 10 transmits the print job of print job ID0001 to the printer 20-1 (S3007).

Upon receipt of print instructions of a print job ID 0001 from a user A (S3008), the printer 20-1 performs print processing based on the print job of the print job ID 0001 (S3009). Upon completion of the print job of the print job ID 0001, the printer 20-1 deletes the print job of the print job ID 0001 (S3010). And the printer 20-1 updates and synchronizes the print job list of the print job ID 0001 (S3011).

For example, in the case that processing information is indicated as “completed” in the synchronized print job list and a printer name is not stored in the accumulation completing printer item, the print server 10 deletes the print job (S3012) and ends processing.

The printing system 1 according to the third embodiment, because a print job is transmitted to a printer 20 in response to a request from the printer 20 in timing which is not based on a user's operation, a user's waiting time can be reduced, when compared with the case of acquiring a print job by waiting a user's operation. Also, there is no communication block by a firewall 40.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing system comprising:
a printing control apparatus and a plurality of printing apparatuses,
wherein the printing control apparatus includes:
an acquisition unit that acquires print information;
a selection unit that selects candidate printing apparatuses from among the plurality of printing apparatuses based on the print information, the candidate printing apparatuses performing print processing which corresponds to the print information;
a list information transmission unit that transmits list information indicating a list of the selected candidate printing apparatuses to one of the selected candidate printing apparatuses; and
a print information transmission unit that transmits the print information to the one of the selected candidate printing apparatuses, and
wherein at least one of the plurality of printing apparatuses includes:
an acquire unit that acquires the list information transmitted from the list information transmission unit; and
a transmission unit, when the one of the selected candidate printing apparatus acquires the print information transmitted from the print information transmission unit, that transmits the print information to at least another printing apparatus which is selected from among the plurality of printing apparatuses by the selection unit and which is indicated in the list information.

2. The printing system according to claim 1, wherein each of the plurality of printing apparatuses further includes:
a request unit that requests transmission of list information indicating the selected printing apparatuses;
a list information acquisition unit that acquires the list information transmitted from the list information transmission unit in response to a request by the request unit; and
a print information transmission request unit, when the list information acquisition unit acquires the list information, that requests transmission of the print information,
wherein the print information transmission unit transmits the print information to a printing apparatus which initially satisfies with predetermined conditions among the printing apparatuses for which the print information transmission request unit requests transmission of the print information in order.

3. The printing system according to claim 2, wherein
each of the plurality of printing apparatuses further includes:
an update unit that updates the print information by adding the information of a printing apparatus maintaining the print information to the list information, and
the print information transmission request unit requests transmission of the print information to the printing apparatus maintaining the print information when the information of the printing apparatus maintaining the print information is added to the list information.

4. The printing system according to claim 3, wherein
the printing apparatuses and the printing control apparatus each further include:
a synchronization unit that synchronizes each of the list information upon comparison of the list information maintained by the printing apparatus and the list information maintained by the plurality of printing apparatuses.

5. The printing system according to claim 1, wherein
the printing control apparatus further includes:
a priority setting unit that sets priority of the selected candidate printing apparatuses,
the list information includes priority information of the selected candidate printing apparatuses set by the priority setting unit, and
the transmission unit transmits the print information to at least one printing apparatus having a higher priority than a priority of a printing apparatus acquiring the print information which is transmitted from the print information transmission unit.

6. The printing system according to claim 1, wherein
each of the plurality of printing apparatuses further includes:
a notification unit that sends notification of performing the print processing corresponding to the print information to each of the printing apparatuses indicated in the list information and the printing control apparatus when each of the plurality of printing apparatuses performs print processing corresponding to the print information, and
the printing apparatuses and the printing control apparatus each further include:
deletion units that delete the print information in response to the notification of the notification unit.

7. A printing control apparatus comprising:
an acquisition unit that acquires print information;
a selection unit that selects candidate printing apparatuses from among a plurality of printing apparatuses based on the print information, the candidate printing apparatuses performing print processing which corresponds to the print information;
a list information transmission unit that transmits list information indicating a list of the selected candidate printing apparatuses to one of the selected candidate printing apparatuses; and
a print information transmission unit that transmits the print information to the one of the selected candidate printing apparatuses, wherein
the printing control apparatus controls the selected printing apparatuses so as to transmit (i) the list information transmitted from the list information transmission unit and (ii) the print information transmitted from the print information transmission unit to at least another printing apparatus which is selected from among the plurality of printing apparatuses by the selection unit and which is indicated in the list information.

8. A printing apparatus in communication with a printing control apparatus, the printing apparatus comprising:
an acquisition unit that acquires print information;
a selection unit that selects candidate printing apparatuses from among a plurality of printing apparatuses based on the print information, the candidate printing apparatuses performing print processing which corresponds to the print information;
a list information transmission unit that transmits list information indicating a list of the selected candidate printing apparatuses to one of the selected candidate printing apparatuses;
a print information transmission unit that transmits the print information to the one of the selected candidate printing apparatuses,
another acquire unit that acquires the list information transmitted from the list information transmission unit; and
a transmission unit, when the one of the selected candidate printing apparatus acquires the print information transmitted from the print information transmission unit, that transmits the print information to at least another printing apparatus which is selected from among the plurality of printing apparatuses by the selection unit and which is indicated in the list information.
